(19) United States
(12) Patent Application Publication
(10) Pub. No.: US 2014/0074556 A1
(43) Pub. Date: Mar. 13, 2014

(54) Method for Financing and Operating Onsite Renewable Energy Systems with Aggregated Onsite Demand

(71) Applicant: James Louis Garner, Fullerton, CA (US)

(72) Inventor: James Louis Garner, Fullerton, CA (US)

(21) Appl. No.: 13/615,550

(22) Filed: Sep. 13, 2012

(51) Int. Cl. G06Q 30/02

(52) U.S. Cl. CPC G06Q 30/0206
USPC 705/7.35

(57) ABSTRACT

An improved method of operating and financing one or more onsite renewable energy systems (16) that supply energy to one or more onsite users (12). Onsite demand aggregation and management produce stable cash flow that qualifies for low cost conventional financing. Key functions, under the control of a professional operator (14), are redesigned to improve operating costs, tax incentive utilization, and risk mitigation. Onsite users (12) receive highly reliable power at retail rates but undertake no investments, long term commitments, or risk.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING

Not Applicable

### BACKGROUND OF INVENTION

### Background—Prior Art

The following is a tabulation of some prior art that presently appears relevant:

### U.S. Patents

| Patent Number | Kind Code | Issue Date | Patentee |
|---|---|---|---|
| 8,175,964 | 705/38 | May 8, 2012 | Arfin |
| 7,904,382 | 705/38 | Mar. 8, 2011 | Arfin |
| 7,890,436 | 705/412 | Feb. 15, 2011 | Kremen |
| 7,809,621 | 705/35 | Oct. 5, 2010 | Herzig |
| 7,747,489 | 705/35 | Jun. 29, 2010 | Perg, et al. |
| 7,698,219 | 705/40 | Apr. 13, 2010 | Kremen, et al. |
| 7,512,540 | 705/412 | Mar. 31, 2009 | Gluck, et al. |

### U.S. Patent Application Publications

| Publication Nr. | Kind Code | Publ. Date | Applicant |
|---|---|---|---|
| 2009/0228320 A1 | 705/35 | Mar. 9, 2009 | Lopez, et al. |
| 2009/0157545 A1 | 705/40 | Nov. 19, 2008 | Mobley |
| 2008/0091589 A1 | 705/38 | Jul. 20, 2007 | Kremen |
| 2008/0091581 A1 | 705/35 | Jan. 12, 2007 | Kremen |

### Other Publications

California Energy Commission Guidebook, “New Solar Homes Partnership, Third Edition” (April 2010)
Farrell, John, New Rules Project Publication, “Community Solar Power, Obstacles and Opportunities” (September 2010)
Hall, Dana, et al., Sustainable Business.com, http://www.sustainablebusiness.com/index.cfm/go/news.feature/id/1791, “Investing in Solar as a Community” (April 2010)
Hirsch, Harold, Regulatory Relations, Pacific Gas and Electric Company, Presentation for Workshop “Virtual Net Metering (VNM) for Multifamily Affordable Solar Housing or How one solar array can provide Net Energy Metering to many individually metered, low income/affordable housing electric customers” (Jan. 8, 2009)
Keiser, Richard, Keiser-Analytics Report, “300 GW Of Demand at $3 Per Watt?” www.keiser-analytics.com (2011)
Mints, Paula, Navigant Consulting, Inc. Report, “Status of US Demand and Supply PVSEC-21” Chart 16 (December 2011)
Rose, James, et al., Freeing the Grid, 2010 Edition, Network for New Energy Choices “Freeing the Grid: Best Practices in State Net Metering Policies and Interconnection Procedures” (December 2010)
The California Center for Sustainable Energy, Report, “Multifamily Affordable Solar Housing Semi-Annual Progress Report” (July 2010)
Wiser, Ryan, et al., Ernest Orlando Lawrence Berkeley National Laboratory Report, “Financing Investments in Renewable Energy: The Role of Policy Design and Restructuring” (March 1997)

Renewable energy systems are becoming economical in a rapidly expanding number of business and residential applications. Photovoltaic (PV) modules are capable of meeting the energy needs of more building space than they, themselves, occupy. Although the raw source of renewable energy (e.g. sunlight, geothermal, etc.) is usually free, the equipment for capturing it requires a large up-front investment, which must be amortized through avoided costs or energy sales over many years. This equipment has little salvage value that can serve as collateral, which means that the availability of financing is highly dependent on the risk of interruptions in cash flow from users of the energy.

For several decades, the costs of solar PV energy have declined at an average rate of about 7%/year and demand has grown at nearly 50%/year both nationally and globally. In some states, such as California, net costs have been relatively flat for several years because government incentives have declined at about the same rate as installation costs. However recently, net costs have started breaking blow this plateau and could drive growth to even higher rates. Keiser Analytics estimates that potential demand in applications that can be economically served by PV energy increase by a factor of 9 for each dollar reduction in installed cost, suggesting a new growth rate much higher than 50%/yr. However, existing financing methods are already being strained and may be incapable of raising capital much faster. Consequently, the availability of financing (rather than cost) is becoming the main constraint limiting the growth of PV installations.

The financing of renewable energy systems involves four basic responsibilities, which are a poor match for the capabilities and interests of both renewable energy users (herein referred to as “users”) and investors in renewable energy projects (herein referred to as “investors”). These responsibilities may be characterized as follows:
a) Ownership—Renewable energy system investments are long term and illiquid, representing significant risks and potential opportunity-costs for investors. Even the safest projects often require government backed feed-in tariffs or loan guarantees. Investors frequently try to reduce investment duration by structuring deals that accelerate amortization or transfer ownership to a user after only a few years. Users have even shorter term investment preferences since both businesses and households generally prefer investing their limited capital in opportunities such as business expansion or nicer homes that have more associated benefits than merely generating a return-on-investment.
b) Tax Benefit Utilization—Government tax incentives are crucial to the economics of renewable energy systems. However, in order to capture the net-present-value of these incentives, much more shelterable income is needed than renewable energy systems alone can generate. Consequently, owners must have large taxable incomes from other businesses. This often adds costly complexity to financial arrangements and greatly limits the field of prospective investors to “tax equity investors” that command high returns. Most individual tax payers are excluded because only “passive income” can be sheltered. Nevertheless, innovations in Power Purchase Agreement (PPA) financing have driven much of the recent growth in renewable energy despite the use of costly tax equity capital and the onerous long term commitments required of users. This demonstrates the value of innovation in financing and the need for more such innovation.
c) Energy Price Risk—Renewable energy costs are relatively constant, determined almost entirely by initial installation and financing costs, whereas utility energy costs inflate over time. The growing difference in these costs represents the economic value of a system. PPAs capture some of this value by stipulating annual price escalations based on projected utility energy cost inflation. Unfortunately, if these projections turn out to be too high, PPA prices can actually climb higher than utility prices, putting a business user at a dangerous cost disadvantage relative to its competitors. The risk of this is especially high in PPAs because developers and investors typically capture most of the economic value of a project in the form of high up-front pricing, leaving little margin of error for the user. Users rarely have the expertise to assess and manage such inflation risk, which could lead to widespread disappointments in the coming years.
d) Early Termination Risk—The risk of interruptions to cash flow when a user moves away is generally too high for a financial investor to underwrite. High costs make it impractical to move a renewable energy system along with its original user. Consequently, the user must usually bear early termination risk either through ownership or by committing to keep up PPA payments in case a replacement user cannot be found. Since most businesses and households move several times during the typical lifespan of a renewable energy system, early termination risk can represent a high expected cost. Even when users accept this risk, investors remain secondarily liable, which generally limits the availability of financing to the most sedentary users with the most exemplary credit or collateral.

By relieving users of most Ownership and Tax Benefit Utilization responsibilities PPA financing has increased renewable energy system market potential mainly for:
residential homes because of historically low utility bill default rates, low vacancy rates, and good collateral as well as
utility, government, institutional, and highly rated corporate facilities that are stable and financially strong enough to make credible long term commitments.

However, for the great majority of potential applications, energy price risk and early termination risk continue to make renewable energy unfeasible. If these risks could be more effectively mitigated, renewable energy would be adopted faster and more sustainably. The most promising new applications would be in serving business and residential rental users because the basic economics are better than for most current applications. Installation costs are lower than for residential homes because economies of scale are better. Avoided costs include electrical distribution costs, making them much higher than in utility applications.

### BRIEF SUMMARY

In accordance with one embodiment, user agreements are negotiated with as many prospective onsite users as possible to purchase energy, during their occupancy, from an operator of onsite renewable energy systems at prices near utility rates and that vary with utility rates. Aggregation of demand from multiple onsite users produces stable net cash flow that justifies low cost conventional financing. Long term user commitments are avoided by continually replacing departing onsite users with new onsite users. Other costs and risks are reduced by systemic improvements in operations, tax incentive utilization, risk mitigation, and reliability.

Advantages

Accordingly several advantages of one or more aspects are as follows. Users receive highly reliable power at fair rates without making investments or long term commitments. Investments and major risks are undertaken by a professional operator with the expertise and incentives to manage operations more efficiently and with less risk than either a user or finance company. Financing availability and costs are improved by reducing cash flow risk through aggregation of demand and elimination of the need for tax equity. Opportunities are created for branded third party services to improve efficiency and train new operators. Cost and risk reductions make renewable energy feasible for large classes of business and residential users that previously could not be served. Other advantages of one or more aspects will be apparent from a consideration of the drawings and ensuing description.

### BRIEF DESCRIPTION OF THE SEVERAL VIEWS OF THE DRAWINGS

Figures

FIG. 1 shows elements of one embodiment.

FIG. 2 shows startup processes.

FIG. 3 shows ongoing processes performed each billing cycle.

FIG. 4 shows ongoing processes performed continuously or as necessary.

### REFERENCE NUMERALS IN FIGURES

| | |
|---|---|
| 12 | onsite users |
| 14 | operator |
| 16 | onsite renewable energy system |
| 18 | investor |
| 20 | user meter |
| 21 | computer system |
| 22 | bypass switch |
| 24 | grid |
| 26 | utility |
| 28 | utility meter |
| 30 | management |
| 32 | determine spot rates of utility |
| 34 | propose and negotiate user agreements |
| 36 | design renewable energy system |
| 38 | secure financing |
| 40 | install renewable energy system |
| 42 | read user meters |
| 44 | calculate charge for each onsite user |
| 46 | invoice each onsite user |
| 48 | collect onsite user payments |
| 49 | replace terminating onsite users |
| 50 | monitor for problems |
| 52 | perform maintenance and repairs |
| 54 | activate bypass switch |
| 56 | evaluate and adjust terms with utility |
| 58 | operate as a business |

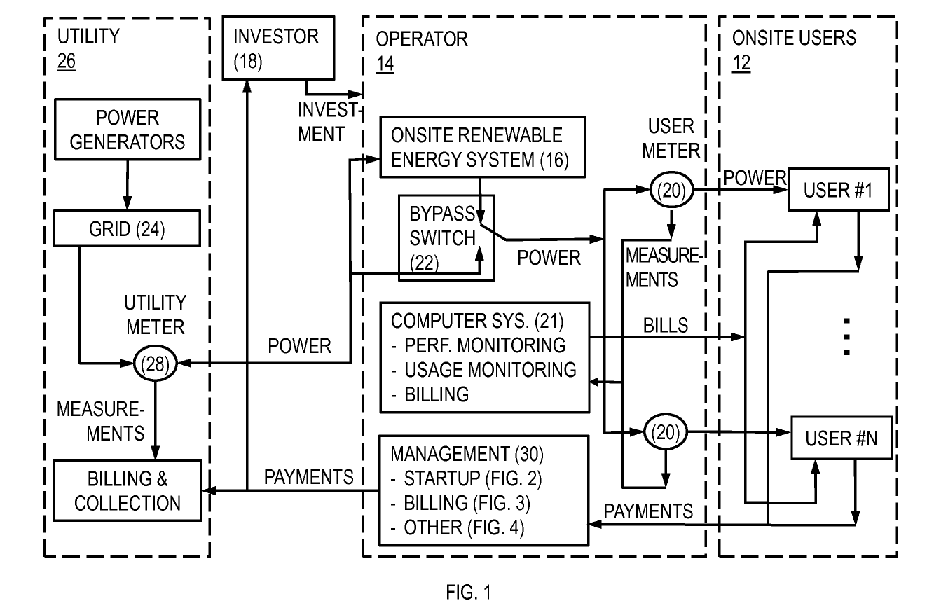

### DETAILED DESCRIPTION—FIG. 1—FIRST EMBODIMENT

One embodiment is illustrated in FIG. 1. One or more onsite users 12 purchase energy from an operator 14 of one or more onsite renewable energy systems 16. A site is a facility with one or more nonresidential (herein referred to as “business”) units, and/or residential units. This embodiment employs standard grid-tied photovoltaic renewable energy systems but alternate embodiments include all other renewable energy generating technologies such as concentrated solar power, wind, hydro, geothermal, biofuel, etc. that produce any form of energy including electric, thermal, and chemical. Onsite users 12 are typically tenants but may have ownership stakes such as condominium arrangements. Operator 14 is typically the site landlord and owner of the renewable energy system 16 but may be an independent business and/or exercise an alternate form of control such as a lease. Operator 14 gets capital to install the system from Investor 18 and makes payments in return. One or more entities may partially or fully undertake multiple responsibilities as utility 20, investor 18, operator 14, or onsite user 12.

Energy from renewable energy system 16 is delivered to each onsite user 12 through user meter 20 that is configured with means to measure and communicate energy usage to computer system 21 either electronically or manually.

Computer system 21 is comprised of one or more computers configured with means to:
a. acquire and track both spot rates that utility 26 would charge onsite users 12 and legal restrictions on rates.
b. receive and store contract rates from user agreements made between onsite users 12 and operator 14.
c. calculate charges according to contract rates in user agreements made between onsite users 12 and operator 14. These may or may not be based on measurements of actual usage,
d. produce invoices for individual onsite users 12.
e. acquire and monitor status information from renewable energy system 16 as well as other hardware and produce alerts when actual performance falls below expected performance or when problems are detected.
f. signal shut-down of renewable energy system 16 and activation of bypass switch 22 in case of failures that would otherwise interrupt supply of power to onsite users 12.

Bypass switch 22 is configured with means to connect power from utility meter 28 directly to user meters 12 when activated by computer system 21, renewable energy system 16, or manually. Bypass switch 22 may be separate external hardware or integrated as part of renewable energy system 16. In alternative embodiments, separate bypass switches 22 may be configured for individual onsite users 12.

Renewable energy system 16 transfers power to and from the power distribution grid (herein referred to as grid 24) operated by an energy utility company (herein referred to as utility 26) through a connection to utility meter 28. Utility meter 28 is comprised of one or more meters capable of measuring net energy flow or of measuring energy flow in each direction separately. Renewable energy system 16 is configured with means to:
receive power from grid 24 when total demand from onsite users 12 exceeds the power output of renewable energy system 16 and
deliver power to grid 24 when total demand from onsite users 12 demand is less than the power output of renewable energy system 16.

In alternative embodiments, an energy storage system or back-up generator system is used instead of, or in addition to, connection to grid 24.

Operation

Three categories of processes are performed as follows:

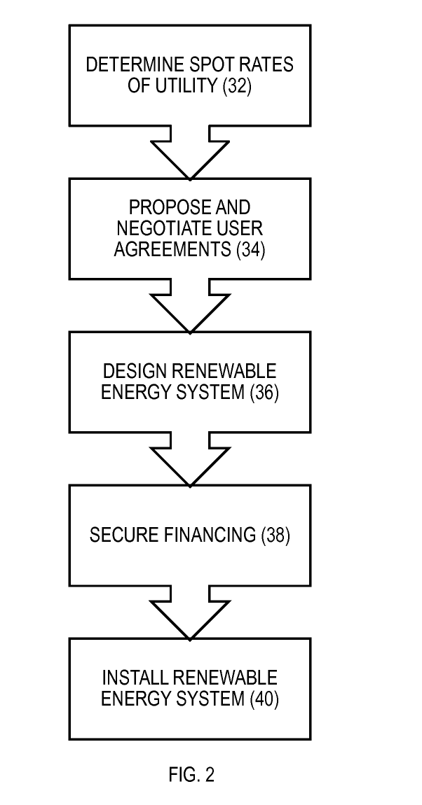

1) Startup Processes—FIGS. 1 and 2
a) Determine spot rates of utility 32 (FIG. 2) that onsite users 12 (FIG. 1) would be charged. These may be different for each onsite user 12 (FIG. 1). Also determine the legal limits for these charges set by governmental agencies such as a public utilities commission or by contract.
b) Propose and negotiate user agreements 34 (FIG. 2) wherein individual onsite users 12 agree to purchase energy from operator 14 (FIG. 1) during onsite occupancy of onsite user 12, at contract rates near, and that vary with, spot rates of utility 32 (FIG. 2). Typically, the contract rate at any given point in time would be 100% of the spot rate at that time.
c) Design renewable energy system 36 (FIG. 2) to optimize expected return-on-investment for projected vacancy rates and demand variations. For example, the system may be sized so that renewable energy system 16 (FIG. 1) capacity is fully utilized at less than full occupancy to allow for a persistent average vacancy rate. Renewable energy system 16 (FIG. 1) should also be designed for future expansion as conditions change.
d) Arrange Financing 38 (FIG. 2) based on the stability of aggregate cash flow from energy sales to end users 12 (FIG. 1). Financing terms should be similar to those for real estate improvements since risk and collateral are comparable. Cash flow risk will actually be lower than for rental revenue because energy can be sold to a local utility during extended vacancies whereas rental revenue drops to zero. The investment involved in a renewable energy system 16 (FIG. 1) represents a small percentage of the value of the underlying real estate and can often be fully collateralized by existing equity in this real estate. When investors 18 require proven cash flow (rather than pro forma estimates), it may be necessary to secure bridge financing or build in phases, so that proven cash flow from a completed phase is used to secure additional financing to build the next phase.
e) Install renewable energy system 40 (FIG. 2) using standard design, permitting, and contracting methods.

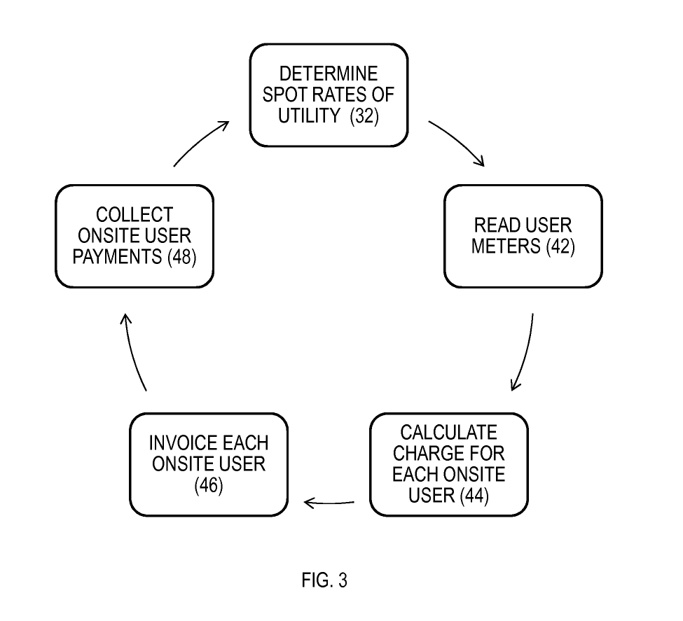

2) Ongoing Processes Performed Each Billing Cycle—FIGS. 1 and 3.
a) Determine spot rates of utility 32 (FIG. 3). Any changes are to be reflected in invoice calculations.
b) Read user meters 42 (FIG. 3) and communicate data from user meters 20 (FIG. 1) to computer system 21 (FIG. 1)
c) Calculate charges for each onsite user 44 (FIG. 3) in computer system 21 (FIG. 1) at contract rates using measurements from user meters 20 (FIG. 1) but subject to legal limits. In alternative embodiments, charges may be based on predetermined allocations instead of measurements of actual energy usage.
d) Invoice each onsite user 46 (FIG. 3) for charges.
e) Collect onsite user payments 48 (FIG. 3) using policies and procedures comparable to those for collecting rents.

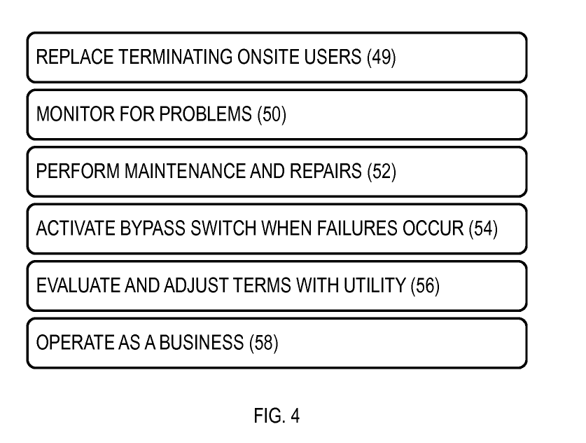

3) Ongoing Processes Performed Continuously or as Necessary—FIGS. 1 and 4
a) Replace terminating onsite users 49 (FIG. 4) with other onsite users 12 (FIG. 1) to ensure steady energy demand and cash flow that justifies low cost financing.
b) Monitor for problems 50 (FIG. 4) both manually as well as with computer system 21 (FIG. 1), producing alerts when power output and other performance falls below expectations or when hardware alert indications are received.
c) Perform maintenance and repairs 52 (FIG. 4) according to programmed service as well as when alerts requiring maintenance or repair action occur.
d) Evaluate and adjust terms with utility 56 (FIG. 4) as conditions change. Typically, energy will be exchanged with utility 26 (FIG. 1) under terms of “Net Metering” (also known as “Net Energy Metering”), wherein energy delivered to utility 26 (FIG. 1) at certain times earns credit at retail rates that is used to purchase energy drawn at other times (but cannot be redeemed for money). However, other terms should be negotiated when significant changes occur in conditions such as vacancy rate, demand by onsite users 12 (FIG. 1), or the rate structure of utility 26 (FIG. 1). For example, during extended periods of high vacancy rate, Net Metering terms may be profitably replaced by a Power Purchase Agreement wherein unused energy is sold to Utility 26 (FIG. 1) for money (albeit at lower, wholesale rates).
e) Operate as a business 58 (FIG. 4). This includes all other aspects of running a normal business similar to real estate rental management such as: general management, paying utility 26 for energy and services, accounting, etc.

### Alternative Embodiments—FIG. 1

Alternative embodiments include, but are not limited to the following:
a) A third party performs some or all startup and ongoing processes for operator 14.
b) A third party developer initially undertakes most startup and ongoing processes, then transfers ownership to a permanent operator. This may involve the use of outsourced services before and/or after ownership transfer.
c) Onsite users 12 purchase renewable energy, when available, from operator 14 but deal directly with utility 26 for other energy requirements.

Advantages

From the description above, a number of advantages of some embodiments of my renewable energy system become evident.
a) A professional operator receives the profits needed to reward and incentivize efficient operation and risk mitigation. Onsite users generally do not share in the profits but are left in the same position as if they continued to purchase power directly from a utility. They pay the same rates for energy of comparable reliability and undertake no investments, no long term commitments, and no risk.
b) Tax Equity is eliminated, lowering financing cost. An operator would typically (though not necessarily) be the landlord of the underlying real estate with sufficient taxable rental income to efficiently capture the net present value of the tax incentive savings.
c) Diversification of risk is achieved at a project level more economically than at a portfolio level. Until now, investors have mitigated risk by diversifying investments into portfolios of multiple projects. However, these incur high legal and fiduciary costs and leave individual project owners with the undiversified risk of a single project. In the current embodiment, the operator mitigates risk of a single project by diversifying sales to multiple onsite users, similar to the way a landlord aggregates rents from multiple tenants. In addition to eliminating high legal and fiduciary costs, risk is more effectively mitigated because the operator has more control over onsite users than passive investors have over projects in a portfolio.
d) Onsite users bear no risk of their contract rates becoming higher than utility rates. This can happen in prior art when preprogrammed PPA rate escalations exceed actual utility rate inflation. Instead, contract rates for onsite users simply track spot rates that a utility would charge, which places onsite users on a level playing field with conventional energy users. Risk to profitability caused by spot rate variability is undertaken by the operator. Such risk is comparable to the risk of rental rate variability, which landlords routinely manage, and can be managed in similar ways.
e) Onsite users make no investment and bear no financial obligations after their occupancy ends. In contrast, the PPAs and direct ownership of prior art leave large un-extinguished liabilities when terminated early because amortization is spread over many years. Since user occupancy requirements are typically much shorter than the useful life of a renewable energy system, early termination costs are an onerous risk for both users and investors. In this embodiment, the operator mitigates this risk by efficiently replacing departing onsite users with other onsite users similar to the way landlords replace departing tenants.
f) Onsite users receive power with reliability comparable to power directly from the grid. When the renewable energy system has problem that could interrupt service, it is bypassed and power from the grid is routed directly to onsite users via a bypass switch.
g) Opportunities are created for branded service businesses that can help improve the performance and efficiency of each process step and help new operators enter the business.
h) Renewable energy system projects become economically viable and financeable for many more users, particularly in business and residential rental applications. These represent a very large, underserved market with better economics than most current applications.
i) Government policy objectives are better served because incentives flow to operators, who are actually in the renewable energy business and likely to use their margins to expand. Whereas, such incentives currently flow mainly to user-owners or to passive investors, both of which are in different businesses and unlikely to allocate much of their savings or profit to renewable energy expansion.

Conclusion, Ramifications, and Scope

Accordingly, the reader will see that renewable energy systems are made viable in many more applications, particularly those that serve business and residential rental users. Government policy objectives for expanding renewable energy are also better served. Additional advantages include:
operating costs are reduced through properly incentivized professional management,
financing costs and availability are improved by aggregating risk at a project level and eliminating the need for costly tax equity,
onsite users bear no risk of renewable energy prices exceeding conventional energy prices,
onsite users make no investment and bear no liability after their occupancy ends, even for short duration occupancies,
opportunities are created for branded service companies to further reduce costs and to train new operators.

Although the description above contains many specificities, these should not be construed as limiting the scope of the embodiments but as merely providing illustrations of some of several embodiments. Thus, the scope of the embodiments should be determined by the appended claims and their legal equivalents, rather than by the examples given.

I claim:

1. A method for financing and operating one or more onsite renewable energy systems that supply energy to one or more onsite users, the method comprising:
a. tracking, by a computer system, spot rates that a utility would charge each said onsite user,
b. offering user agreements wherein individual onsite users agree to purchase energy from an operator of said one or more onsite renewable energy systems, at contract rates near, and that vary with, said spot rates, during the onsite occupancy of said onsite user,
c. replacing energy demand of said onsite users that terminate occupancy with demand of other said onsite users,
d. arranging financing for said one or more onsite renewable energy systems based on the stability of aggregate cash flow from sales of energy in accordance with said user agreements with at least one said onsite user,
e. providing said one or more onsite renewable energy systems having means to supply power to said onsite users in accordance with said user agreements and,
f. calculating charges and producing invoices, by said computer system, for said onsite users in accordance with said user agreements,
whereby financing costs and availability are improved by mitigating risk through aggregation and active management of demand, operating costs are reduced through professional management by said operator, and said onsite users receive renewable energy at fair prices without investment or long term commitments even for short duration occupancy.

2. The method as recited in claim 1 in which some or all functions of said operator are outsourced to one or more third parties.

3. The method as recited in claim 1 further comprising calculating said charges, by said computer system, based on actual energy usage measured by power meters.

4. The method as recited in claim 1 further comprising selling excess renewable energy to said utility during extended periods of low energy demand, whereby interruptions in cash flow are minimized by preserving much of the value of generated renewable energy in situations such as high vacancy rate.

5. The method as recited in claim 1 further comprising monitoring for problems and producing alerts, by said computer system, when actual performance of said one or more renewable energy systems falls below expected performance or when hardware alert signals are received.

6. The method as recited in claim 1 further comprising activating a bypass switch having means to connect onsite users directly to power from said utility upon failure of said one or more renewable energy systems, whereby power reliability for said onsite users remains essentially the same as power received directly from said utility.

7. The method as recited in claim 1 further comprising designing said one or more renewable energy systems to optimize expected return-on-investment under expected operating conditions such as vacancy rate and demand variability.

8. A method for financing and operating one or more onsite renewable energy systems that supply energy to one or more onsite users, wherein a third party performs some or all processes for an operator of said one or more onsite renewable energy systems, the method comprising:
a. tracking, by a computer system, spot rates that a utility would charge each said onsite user,
b. offering user agreements wherein individual onsite users agree to purchase energy from said operator of said one or more onsite renewable energy systems, at contract rates near, and that vary with, said spot rates, during the onsite occupancy of said onsite user,
c. replacing energy demand of said onsite users that terminate occupancy with demand of other said onsite users,
d. arranging financing for said one or more onsite renewable energy systems based on the stability of aggregate cash flow from sales of energy in accordance with said user agreements with at least one said onsite user,
e. providing said one or more onsite renewable energy systems having means to supply power to said onsite users in accordance with said user agreements and,
f. calculating charges and producing invoices, by said computer system, for said onsite users in accordance with said user agreements,
whereby financing costs and availability are improved by mitigating risk through aggregation and active management of demand, operating costs are reduced through professional management by said operator, and said onsite users receive renewable energy at fair prices without investment or long term commitments even for short duration occupancy.

9. The method as recited in claim 8 further comprising said third party initially undertaking all responsibilities of an operator and later arranging transfer of ownership to said operator.

10. The method as recited in claim 8 further comprising calculating said charges, by said computer system, based on actual energy usage measured by power meters.

11. The method as recited in claim 8 further comprising selling excess renewable energy to said utility during extended periods of low energy demand, whereby interruptions in cash flow are minimized by preserving much of the value of generated renewable energy in situations such as high vacancy rate.

12. The method as recited in claim 8 further comprising monitoring for problems and producing alerts, by said computer system, when actual performance of said one or more renewable energy systems falls below expected performance or when hardware alert signals are received.

13. The method as recited in claim 8 further comprising activating a bypass switch having means to connect onsite users directly to power from said utility upon failure of said one or more renewable energy systems, whereby power reliability for said onsite users remains essentially the same as power received directly from said utility.

14. The method as recited in claim 8 further comprising designing said one or more renewable energy system to optimize expected return-on-investment under expected conditions such as vacancy rate and demand variability.

15. A system that supplies renewable energy for sale by an operator to one or more onsite users at contract rates near, and that vary with, spot rates that a utility would charge, the system comprising:
a. one or more onsite renewable energy systems configured with means to supply power to said one or more onsite users and,
b. a computer system comprising one or more computers and means to:
i. acquire and store information on said spot rates,
ii. store information on said contract rates,
iii. close accounts for departing said onsite users and open accounts for new said onsite users, and
iv. calculate charges and produce invoices, in accordance with said contract rates, during onsite occupancy of each said onsite user,
whereby financing costs and availability are improved by mitigating risk through aggregation and active management of demand, operating costs are reduced through professional management by said operator, and said onsite users receive renewable energy at fair prices without investment or long term commitments.

16. The system as recited in claim 15 wherein energy meters are configured with means to measure usage by each said onsite user and communicate said measurements to said computer system for use in calculating said charges.

17. The system as recited in claim 15 wherein said one or more onsite renewable energy systems are configured with means to deliver net energy for sale to said utility during periods of low energy demand whereby interruptions in cash flow are minimized by preserving much of the value of generated renewable energy in situations such as high vacancy rate.

18. The system as recited in claim 15 wherein said computer system is configured with means to produce alert signals when actual performance of said one or more onsite renewable energy systems falls below expected performance or when hardware alert signals are received.

19. The system as recited in claim 15 wherein a bypass switch is configured to connect onsite users directly to power from said utility when said one or more onsite renewable energy systems fail, whereby power reliability for said onsite users remains essentially the same as power received directly from said utility.

20. The system as recited in claim 15 wherein said one or more onsite renewable energy systems are designed to optimize expected return-on-investment under expected operating conditions such as vacancy rate and demand variability.
